(19) United States
(12) Patent Application Publication
(10) Pub. No.: US 2024/0384076 A1
(43) Pub. Date: Nov. 21, 2024

(54) RESIN COMPOSITION AND MOLDED PRODUCT THEREOF, MULTILAYER STRUCTURE, AND ETHYLENE-VINYL ALCOHOL COPOLYMER RECOVERY AID

(71) Applicant: Mitsubishi Chemical Corporation, Tokyo (JP)

(72) Inventors: Kota TERAOKA, Tokyo (JP); Kohei KIKUCHI, Tokyo (JP)

(73) Assignee: Mitsubishi Chemical Corporation, Tokyo (JP)

(21) Appl. No.: 18/786,890

(22) Filed: Jul. 29, 2024

Related U.S. Application Data
(63) Continuation of application No. PCT/JP2023/011721, filed on Mar. 24, 2023.

(30) Foreign Application Priority Data
Mar. 24, 2022 (JP) 2022-048752

(51) Int. Cl. C08L 23/06

(52) U.S. Cl. CPC C08L 23/06; C08L 2201/10; C08L 2205/03; C08L 2207/06

(57) ABSTRACT

Provided is a resin composition which can be molded into a product with excellent transparency, as a recycled composition of a multilayer structure using a polyolefin resin and an ethylene-vinyl alcohol copolymer. The resin composition comprises a polyolefin resin (A), an ethylene-vinyl alcohol copolymer (B), and an amine-modified resin (C), wherein the content of the amine-modified resin (C) is 0.1 to 20 parts by mass per 100 parts by mass of the polyolefin resin (A).

### RELATED APPLICATIONS

This application is a continuation of International Application No. PCT/JP2023/011721, filed on Mar. 24, 2023, which claims priority to Japanese Patent Application No. 2022-048752, filed on Mar. 24, 2022, the entire contents of each of which are herein incorporated by reference.

### TECHNICAL FIELD

The present disclosure relates to a resin composition, a molded product by molding the resin composition, a multilayer structure, and an ethylene-vinyl alcohol copolymer recovery aid.

### BACKGROUND ART

In order to reduce the amount of plastic packaging waste, a recycling technology is known in which scraps generated during the process of manufacturing multilayer structures using non-polar resins such as polyolefin resins and barrier polar resins such as ethylene-vinyl alcohol copolymers (EVOHs) are collected, pulverized by crushing or other methods, melt kneaded to resin compositions, granulated/molded, and reused as regrind layers of multilayer structures. However, a problem with the resin compositions obtained in this way is that EVOHs and polyolefin resins therein are not easily compatible with each other. As a result, there is a problem of poor recyclability because EVOHs aggregate within the recycled resin layers and affect the quality of the multilayer structures after recycling.

In response to the above problems, JP-A-2021-88684 describes a resin composition containing 0.1 to 20 parts by mass of an ethylene-vinyl alcohol copolymer (B) having an ethylene unit content of 15 to 60 mol % and a saponification degree of 85 mol % or more, and 0.1 to 10 parts by mass of a block copolymer (C) of an aromatic vinyl compound and an olefin per 100 parts by mass of a polyolefin (A), wherein the block copolymer (C) of the aromatic vinyl compound and the olefin has at least one group selected from the group consisting of a halogen, an epoxy group, a carboxyl group, and a group having a carboxylic anhydride structure, to improve recyclability.

### SUMMARY

### Problems to Be Solved by the Disclosure

Although recyclability is improved by using the resin composition described in JP-A-2021-88684 in the above recycling technology, there is room for improvement in the transparency of the molded product obtained from such a resin composition.

The present disclosure has been made in view of the above problem and provides a resin composition which can improve the transparency of a molded product obtained by recycling scraps generated during the process of manufacturing multilayer structures using non-polar resins such as polyolefin and EVOH, a molded product obtained by molding said resin composition, a multilayer structure, and an EVOH recovery aid that enhances the recyclability of EVOH.

### Means for Solving the Problems

As a result of intensive studies to solve the above problem, the present inventors have found that by adding an amine-modified resin to a resin composition containing a polyolefin resin and an EVOH, the transparency of a molded product obtained by molding said resin composition can be improved.

That is, the present disclosure provides the following [1] to [8].
[1] A resin composition comprising a polyolefin resin (A), an ethylene-vinyl alcohol copolymer (B), and an amine-modified resin (C), wherein the content of the amine-modified resin (C) is 0.1 to 20 parts by mass per 100 parts by mass of the polyolefin resin (A).
[2] The resin composition according to [1], wherein the content of the ethylene-vinyl alcohol copolymer (B) is 0.1 to 20 parts by mass per 100 parts by mass of the polyolefin resin (A).
[3] The resin composition according to [1], wherein the content of the ethylene-vinyl alcohol copolymer (B) and the content of the amine-modified resin (C) are 0.1 to 20 parts by mass and 0.1 to 20 parts by mass, respectively, per 100 parts by mass of the polyolefin resin (A).
[4] A resin composition according to any one of claims [1] to [3], wherein the amine-modified resin (C) is an amine-modified block copolymer of an aromatic vinyl compound and an olefin.
[5] The resin composition according to any one of [1] to [4], further comprising 0.1 to 20 parts by mass of an acid-modified polyolefin resin (D) per 100 parts by mass of the polyolefin resin (A).
[6] A molded product comprising the resin composition according to any one of [1] to [5].
[7] A multilayer structure having at least one layer containing the resin composition according to any one of [1] to [5].
[8] A method of enhancing recyclability of a combination of an ethylene-vinyl alcohol copolymer and a polyolefin resin, comprising: adding an amine-modified resin (C) to the combination of the ethylene-vinyl alcohol copolymer and the polyolefin resin.

### Effects of the Disclosure

According to the resin composition of the present disclosure, it is possible to mold a highly transparent molded product without compromising the transparency of the resin composition obtained by recycling scraps generated during the process of manufacturing multilayer structures using polyolefin resin and EVOH (hereinafter, may be referred to as “recycled composition” or “regrind composition”).

Note that the resin composition of the present disclosure is not limited to those containing polyolefin resin and EVOH as recycled materials, and can also be effectively applied to cases where either or both of these are virgin resins.

### EMBODIMENTS OF THE DISCLOSURE

Hereinafter, embodiments of the present disclosure will be described in detail. The present disclosure is not limited to the following description, but can be implemented in any variations without departing from the spirit and scope of the present disclosure.

Herein, when numerical values or physical property values are put before and after the term “to” to express a range, the term “to” is used in the sense that the range includes the values before and after the term “to”.

When an expression “X or more” (X is any number) or “Y or less” (Y is any number) is used, it also encompasses the meaning “preferably more than X” or “preferably less than Y”.

Furthermore, “X and/or Y (X and Y are any component)” means at least one of X and Y, and has three meanings of X alone, Y alone, and both X and Y.

Hereinafter, a monomer unit contained in a copolymer resin may simply be referred to as “unit”. For example, a monomer unit based on ethylene may be referred to as “ethylene unit”.

In the present disclosure, the melt flow rates (MFRs) and densities of resins are values measured as described below.

### MFR

MFRs are measured according to JIS K7210 under the conditions of 190° C. (for an ethylene resin among polyolefin resins (A)), 210° C. (for a propylene resin among polyolefin resins (A), and an EVOH (B)), or 230° C. (for an amine-modified resin (C)), and a load of 2.16 kg.

### Density

The densities are measured by the water displacement method according to JIS K7112.

### Resin Composition

The resin composition of the present disclosure contains a polyolefin resin (A), an ethylene-vinyl alcohol copolymer (B), and an amine-modified resin (C), wherein the content of the amine-modified resin (C) is 0.1 to 20 parts by mass per 100 parts by mass of the polyolefin resin (A).

### Polyolefin Resin (A)

Examples of the polyolefin resin (A) include: polypropylene; propylene copolymer produced by copolymerizing propylene and α-olefin such as ethylene, 1-butene, 1-hexene, or 4-methyl-1-pentene; polyethylene such as low-density polyethylene, linear low-density polyethylene, medium-density polyethylene, or high-density polyethylene; ethylene copolymer produced by copolymerized ethylene and α-olefin such as 1-butene, 1-hexene, or 4-methyl-1-pentene; and poly(1-butene), poly(4-methyl-1-pentene).

The polyolefin resins (A) may be used alone, or two or more of them having different copolymerization component composition, physical properties, or the like may be used in a mixture.

In particular, as the polyolefin resin (A), propylene resins such as polypropylene and propylene copolymer, and ethylene resins such as polyethylene, high-density polyethylene and ethylene copolymer are preferred.

When the resin composition of the present disclosure contains an acid-modified polyolefin resin (D) described below, the polyolefin resin (A) refers to polyolefin resins other than the acid-modified polyolefin resin (D).

The melt flow rate (MFR: 190° C. or 210° C., a load of 2.16 kg) of the polyolefin resin (A) is preferably 0.01 to 10 g/10 min. When the MFR of the polyolefin resin (A) is 0.01 g/10 min. or more, the difference in melt viscosities between the EVOH (B) and the polyolefin resin (A) does not become too large, and the dispersibility of the EVOH (B) in the resin composition tends to be better. On the other hand, when the MFR of the polyolefin resin (A) is 10 g/10 min. or less, the impact resistance of the resulting molded product tends to be better. The MFR of the polyolefin resin (A) is more preferably 5 g/10 min. or less, further preferably 3 g/10 min. or less, and particularly preferably 2 g/10 min. or less. When a mixture of a plurality of resins is used as the polyolefin resin (A), the MFR of the polyolefin resin (A) is the weighted mean of the MFR of each resin in the mixture by the mass ratio. When the EVOH (B), the amine-modified resin (C), and the acid-modified polyolefin resin (D), which are described below, are mixtures of a plurality of resins, their MFRs are determined in the same manner as for the polyolefin resin (A).

### EVOH (B)

The EVOH (B) can be obtained by saponifying an ethylene-vinyl ester copolymer. Vinyl acetate is a typical example of vinyl ester, and other fatty acid vinyl esters such as vinyl propionate and vinyl pivalate can also be used. Ethylene-vinyl ester copolymers can be manufactured by any known polymerization method, such as solution polymerization, suspension polymerization, or emulsion polymerization, and ethylene-vinyl ester copolymers can also be saponified by known methods.

The ethylene unit content of the EVOH (B) is measured based on ISO 14663, and is preferably 20 to 60 mol %. When the ethylene unit content is 20 mol % or more, the EVOH (B) in the resin composition has good gas barrier properties under high humidity conditions and good melt moldability. The ethylene unit content of the EVOH (B) is more preferably 23 mol % or more. When the ethylene unit content is 60 mol % or less, the barrier properties is excellent. The ethylene unit content of the EVOH (B) is more preferably 55 mol % or less, and further preferably 50 mol % or less.

The saponification degree of the vinyl ester units in the EVOH (B), which is measured based on JIS K6726 (in a solution in which EVOH is uniformly dissolved in a water/methanol solvent), is preferably 80 mol % or more, more preferably 98 mol % or more, and further preferably 99 mol % or more in terms of barrier properties, thermal stability, and moisture resistance.

The melt flow rate (MFR: 210° C., a load of 2.16 kg) of the EVOH (B) is preferably 0.1 to 100 g/10 min. When the MFR of the EVOH (B) is 100 g/10 min. or less, the difference in melt viscosities between the EVOH (B) and the polyolefin resin (A) does not become too large, resulting in a tendency for better dispersibility of the EVOH (B) in the resin composition and better thermal stability. The MFR of the EVOH (B) is more preferably 50 g/10 min. or less, and further preferably 30 g/10 min. or less. On the other hand, when the MFR of the EVOH (B) is 0.1 g/10 min. or more, the difference in viscosity with the polyolefin resin (A) does not become too large, and the dispersibility of the EVOH (B) in the resin composition tends to be better. The MFR of the EVOH (B) is more preferably 0.5 g/10 min. or more.

The EVOH (B) may contain polymerizable monomers other than ethylene and vinyl ester, copolymerized within a range that does not inhibit the effects of the present disclosure, generally within the range of 5 mol % or less. Examples of such polymerizable monomer include, for example: α-olefins such as propylene, isobutene, α-octene, α-dodecene, and α-octadecene; hydroxy group-containing α-olefins such as 3-buten-1-ol, 4-penten-1-ol, and 3-buten-1,2-diol, or hydroxy group-containing α-olefin derivatives such as esters or acylates thereof; hydroxymethylvinylidene diacetates such as 1,3-diacetoxy-2-methylenepropane, 1,3-dipropionyloxy-2-methylenepropane, and 1,3-dibutyronyloxy-2-methylenepropane; unsaturated carboxylic acids or their salts, partial alkyl esters, complete alkyl esters, nitriles, amides or anhydrides; unsaturated sulfonic acids or salts thereof; vinylsilane compounds; vinyl chloride; and styrene. These may be used alone, or two or more of them may be used in combination.

Furthermore, a “post modified” EVOH such as urethanized, acetalizated, cyanoethylated, or oxyalkylenated EVOH can be also used as the EVOH (B).

EVOHs (B) may be used alone, or two or more of them having different vinyl ester types, ethylene unit content, physical properties, or the like may be used in a mixture.

### Amine-Modified Resin (C)

Examples of the amine-modified resin (C) include a graft-modified resin obtained by graft-modifying a resin with an amine compound, and a copolymer resin obtained by copolymerizing a monomer and an amine compound. These may be used alone, or two or more of them may be used in combination.

Resin types used as amine-modified resins (C) are not particularly limited, but include, for example: polypropylene; propylene copolymers produced by copolymerizing propylene and α-olefin such as ethylene, 1-butene, 1-hexene, or 4-methyl-1-pentene; polyethylene such as low-density polyethylene, linear low-density polyethylene, medium-density polyethylene, or high-density polyethylene; ethylene copolymers produced by copolymerized ethylene and α-olefin such as 1-butene, 1-hexene, or 4-methyl-1-pentene; and poly(1-butene), poly(4-methyl-1-pentene). In terms of compatibility with the polyolefin resin (A), ethylene-a-olefin copolymers and olefin-containing block copolymers are preferable, and block copolymers of aromatic vinyl compounds and olefins such as styrenic thermoplastic elastomers or hydrogenated styrenic thermoplastic elastomers (for example, partially hydrogenated or hydrogenated styrene-butadiene copolymers) are particularly preferable. Also, monomers to be copolymerized with amine compounds are not particularly limited, but include the monomers constituting the resin types described above.

The amine compounds used for modification are not limited, but specifically include alkylamines, alkenylamines, arylamines, arylalkylamines, cyclic alkylamines, and heterocyclic amines.

Examples of alkylamines include methylamine, ethylamine, propylamine, isopropylamine, n-butylamine, sec-butylamine, isobutylamine, tert-butylamine, and pentylamine. Examples of alkenylamines include dodecenylamines, octadecenylamines, and docosenylamines. Examples of arylamines include aniline, methylaniline, ethylaniline, p-isopropylaniline, and N-methylaniline. Examples of arylalkylamines include benzylamine, 1-phenylethylamine, and 2-phenylethylamine. Examples of cyclic alkylamines include cyclohexylamine and dicyclohexylamine. Examples of heterocyclic amines include thienylamine and quinolylamine. These amine compounds may be used alone, or two or more of them appropriately selected may be used in combination.

Using the amine-modified resin (C) enables the EVOH (B), which is a barrier polar resin, to be finely dispersed in the polyolefin resin (A), which is a non-polar resin. As a result, in the recycled composition in which the EVOH (B) is dispersed, the transparency of the polyolefin resin (A) can be improved, and good transparency of the film obtained by molding the recycled composition (hereinafter, may be referred to as “recycled film”) can be kept.

The melt flow rate (MFR: 230° C., a load of 2.16 kg) of the amine-modified resin (C) is preferably 0.01 to 50 g/10 min., more preferably 0.1 to 20 g/10 min., particularly preferably 0.3 to 10 g/10 min. When the MFR of the amine-modified resin (C) is within the above range, the balance of viscosities between the amine-modified resin (C) and the polyolefin resin (A) becomes favorable. As a result, the dispersibility of the EVOH (B) tends to improve further.

The amine content in the amine-modified resin (C) is not particularly limited, but is preferably 0.001 to 20% by mass, more preferably 0.01 to 10% by mass, further preferably 0.1 to 5% by mass, particularly preferably 0.5 to 3% by mass of the amine-modified resin (C). When the amine content in the amine-modified resin (C) is within the above range, the dispersibility of the EVOH (B) in the resin composition of the present disclosure tends to be further improved, and the moldability tends to be improved.

The density of the amine-modified resin (C) is not particularly limited, but is preferably 0.855 to 0.955 g/cm³. When the density of the amine-modified resin (C) is within the above range, it tends to be able to maintain the appearance of the recycled film better and prevent the mechanical properties from deteriorating.

Commercially available products can also be used as the amine-modified resin (C) suitable for the present disclosure, such as “Tuftec (registered trademark) MP10” manufactured by Asahi Kasei Corporation.

### Acid-Modified Polyolefin Resin (D)

The resin composition of the present disclosure may contain, as needed, the acid-modified polyolefin resin (D) which can be used in adhesive resin layers or the like of multilayer structures to be recycled. Examples of the acid-modified polyolefin resin (D) include graft-modified polyolefins obtained by graft-modifying polyolefins with acids, and olefin copolymers obtained by copolymerizing olefins and acids. These may be used alone, or two or more of them may be used in combination. In particular, modified polyolefins modified by unsaturated carboxylic acids and/or derivatives thereof are preferable, and in terms of more excellent compatibility with the polyolefin resin (A), the acid-modified polyolefin resin (D) is preferably obtained by acid-modifying the same type of polyolefin resin as the polyolefin resin (A). For example, when the polyolefin resin (A) is polypropylene, the acid-modified polyolefin resin (D) is preferably acid-modified polypropylene, and when the polyolefin resin (A) is polyethylene, the acid-modified polyolefin resin (D) is preferably acid-modified polyethylene.

Examples of unsaturated carboxylic acid used to modify the acid-modified polyolefin resin (D) include acrylic acids, methacrylic acids, fumaric acids, itaconic acids, and maleic acids, and examples of derivatives thereof include acid anhydrides such as maleic anhydride and itaconic anhydride. Among these, maleic anhydride is most suitable.

The melt flow rate (MFR: 190° C., a load of 2.16 kg) of the acid-modified polyolefin resin (D) is 0.01 g/10 min. or more and less than 15 g/10 min., preferably 0.5 to 10 g/10 min. When the MFR of the acid-modified polyolefin resin (D) is within the above range, the balance of viscosities between the acid-modified polyolefin resin (D) and the polyolefin resin (A) becomes favorable. As a result, the dispersibility of the EVOH (B) tends to improve further.

Further, the density of the acid-modified polyolefin resin (D) is preferably 0.855 to 0.955 g/cm³. When the density of the acid-modified polyolefin resin (D) is within the above range, it tends to be able to further prevent the recycled film's mechanical properties from deteriorating.

The amount of unsaturated carboxylic acid and/or derivatives thereof contained in the acid-modified polyolefin resin (D) is not particularly limited, but is preferably 0.001 to 20% by mass, more preferably 0.01 to 10% by mass, further preferably 0.1 to 5% by mass, particularly preferably 0.5 to 3% by mass of the acid-modified polyolefin resin (D). When the amount of unsaturated carboxylic acid and/or derivatives thereof in the acid-modified polyolefin resin (D) is within the above range, the dispersibility of the EVOH (B) in the resin composition of the present disclosure tends to improve further.

Acid-modified polyolefin resins (D) may be used alone, or two or more of them having different resin types used before modification, physical properties, or the like may be used in a mixture.

### Proportion of Composition

The resin composition of the present disclosure contains the polyolefin resin (A), the EVOH (B), and the amine-modified resin (C), wherein the content of the amine-modified resin (C) is 0.1 to 20 parts by mass per 100 parts by mass of the polyolefin resin (A). The content proportion of the EVOH (B) is not particularly limited, but is preferably 0.1 to 20 parts by mass of the EVOH (B) per 100 parts by mass of the polyolefin resin (A).

When the content of the EVOH (B) is less than 0.1 parts by mass per 100 parts by mass of the polyolefin resin (A), the barrier properties due to the EVOH (B) cannot tend to be obtained sufficiently. On the other hand, when the content of the EVOH (B) exceeds 20 parts by mass, the impact resistance of the resulting molded product tends to decrease. The content of the EVOH (B) is more preferably 1 to 15 parts by mass per 100 parts by mass of the polyolefin resin (A), particularly preferably 5 to 10 parts by mass.

When the content of the amine-modified resin (C) is less than 0.1 parts by mass per 100 parts by mass of the polyolefin resin (A), the dispersibility of the EVOH (B) in the resin composition tends to decrease, resulting in reduced transparency of the obtained molded product. On the other hand, when the content of the amine-modified resin (C) exceeds 20 parts by mass, the transparency and the impact resistance of the resulting molded product tend to decrease. The content of the amine-modified resin (C) is more preferably 1 to 18 parts by mass per 100 parts by mass of the polyolefin resin (A), further preferably 3 to 15 parts by mass, particularly preferably 5 to 10 parts by mass.

When the resin composition of the present disclosure contains the acid-modified polyolefin resin (D), the content proportion thereof is not particularly limited, but is preferably 0.1 to 20 parts by mass of the acid-modified polyolefin resin (D) per 100 parts by mass of the polyolefin resin (A). The content of the acid-modified polyolefin resin (D) is more preferably 1 to 18 parts by mass per 100 parts by mass of the polyolefin resin (A), further preferably 3 to 15 parts by mass, particularly preferably 5 to 10 parts by mass.

The proportion of the polyolefin resin (A), the EVOH (B), and the amine-modified resin (C) in the resin composition of the present disclosure is not particularly limited, but is preferably 50% by mass or more, more preferably 70% by mass or more, further preferably 80% by mass or more, and particularly preferably 90% by mass or more, and may be 95% by mass or more, or 100% by mass.

### Other Component

The resin composition of the present disclosure can contain resins other than the polyolefin resin (A), the EVOH (B), and the amine-modified resin (C), any additives, or the like (hereinafter, these are referred to as “other component”) depending on various purposes, within a range not substantially impairing the effects of the present disclosure. The other components may be used alone, or two or more may be used in any combination and ratio.

Examples of additives include antioxidants, ultraviolet absorbers, plasticizers, lubricants, fillers, and antistatic agents. The total content of these additives in the resin composition of the present disclosure is typically 50% by mass or less, preferably 20% by mass or less, more preferably 10% by mass or less.

### Method of Manufacturing Resin Composition

The methods of mixing each component to obtain the resin composition of the present disclosure are not particularly limited, but include: a method of dry-blending the polyolefin resin (A), the EVOH (B), the amine-modified resin (C), and optionally other components at one time, and melt kneading them; a method of melt kneading a portion of the polyolefin resin (A), the EVOH (B), the amine-modified resin (C), and optionally other components in advance, followed by blending other compounds thereinto and melt kneading them; a method of blending a multilayer structure containing a portion or all of the polyolefin resin (A), the EVOH (B), the amine-modified resin (C), and optionally other components, and other compounds, and melt kneading them.

As a method of manufacturing the resin composition of the present disclosure, a method of melt kneading a recovered multilayer structure comprising the polyolefin resin (A) layer and the EVOH (B) layer with an EVOH recovery aid containing the amine-modified resin (C) is preferred. Here, the recovered multilayer structure refers to recovered scrap such as burrs or rejects generated during the manufacture of molded products obtained from said multilayer structure. In the present disclosure, additives blended during melt kneading of such recovered multilayer structures are called EVOH recovery aids, and EVOH recovery aids containing the amine-modified resin (C) are used.

Examples of a specific method for melt kneading include uniformly mixing each component at a predetermined blending ratio using a Henschel mixer, ribbon blender, V-type blender, etc., and then kneading them using a multi-screw kneading extruder such as the twin-screw kneading extruder TEX 25 from The Japan Steel Works, Ltd.

The temperature for melt kneading each component is typically 100 to 300° C., preferably 120 to 280° C., and more preferably 150 to 250° C.

### Molded Product

The molded product of the present disclosure is obtained by molding the resin composition of the present disclosure.

Examples of shapes of the molded products of the present disclosure include films, sheets, tapes, cups, trays, tubes, bottles, pipes, filaments, profile extrusion products, and various irregularly shaped molded articles.

The molding method for the resin composition of the present disclosure is not particularly limited, and any molding method applicable to general resin compositions may be applied.

For example, extrusion molding, blow molding, injection molding, thermoforming, or the like may be applied.

Furthermore, in molding, a heat stretching process is often applied to improve the physical properties of the molded product or to mold it into any desired container shape. The heat stretching process herein means that a thermally uniformly heated molded article in the shape of a film, a sheet or a parison is uniformly molded into the shape of a cup, a tray, a tube, a bottle, a film using a chuck, a plug, vacuum force, compressed-air force, blowing, or the like. Examples of the stretching methods include roll stretching, tenter stretching, tubular stretching, stretching blow molding, vacuum molding, pressure molding, and vacuum pressure molding. The stretching may be either uniaxial or biaxial, and in case of biaxial stretching, either simultaneous biaxial stretching method or sequential biaxial stretching method may be used. The temperature for stretching is typically 60 to 170° C., further preferably 80 to 160° C.

In addition to the molded product described above, the resin composition of the present disclosure is generally used as at least one layer (regrind layer) of a multilayer structure. The multilayer structure including the regrind layer (also simply referred to as “multilayer structure”) will be described below.

### Multilayer Structure Including Regrind Layer

The multilayer structure including a regrind layer needs only to have at least one layer containing the resin composition of the present disclosure (hereinafter, also referred to as “regrind layer” or “Reg layer”) in its laminate, and generally may include, in addition to regrind layers, a polyolefin resin layer (hereinafter, also referred to as “PO layer”), an EVOH layer, an acid-modified polyolefin layer (hereinafter, also referred to as “acid-modified PO layer”), or the like.

Specific examples of the layer composition of the multilayer structure including the Reg layer include PO layer/Reg layer/acid-modified PO layer/EVOH layer, PO layer/Reg layer/acid-modified PO layer/EVOH layer/acid-modified PO layer/PO layer, and PO layer/Reg layer/acid-modified PO layer/EVOH layer/acid-modified PO layer/Reg layer/PO layer, as well as Reg layer/EVOH layer, Reg layer/acid-modified PO layer/EVOH layer, Reg layer/acid-modified PO layer/EVOH layer/acid-modified PO layer/EVOH layer, Reg layer/acid-modified PO layer/EVOH layer/acid-modified PO layer/PO layer, Reg layer/acid-modified PO layer/EVOH layer/acid-modified PO layer/Reg layer/PO layer, and PO layer/acid-modified PO layer/EVOH layer/Reg layer/EVOH layer/acid-modified PO layer/PO layer, and the like.

Although the thickness of each layer of the multilayer structure including the regrind layer cannot be generalized depending on the layer composition, the type of polyolefin resin, the application, the shape of the container, the required physical properties, or the like, the thickness of regrind layer is typically 5 to 5000 μm, and preferably 30 to 1000 μm. The thickness of the EVOH layer is typically 5 to 500 μm, and preferably 10 to 200 μm. The thickness of the polyolefin resin layer is typically 5 to 5000 μm, and preferably 30 to 1000 μm. The thickness of the acid-modified PO layer is typically 5 to 400 μm, and preferably 10 to 150 μm.

The thickness ratio of the regrind layer/the polyolefin resin layer is typically ⅕ to 10/1, and preferably ½ to 5/1. The thickness ratio of the regrind layer/the EVOH layer is typically 1/1 to 100/1, and preferably 5/1 to 20/1.

### Method of Manufacture of Multilayer Structure Including Regrind Layer

Such a multilayer structure including a regrind layer can be manufactured, for example, by molding using the same type of resin as the multilayer structure to be recovered and the same type of method. In this case, the molding method for the resin composition of the present disclosure is not particularly limited, and any molding method applicable to general resin compositions may be applied. Specifically, it can be manufactured using the polyolefin resin used in the polyolefin resin layer and the EVOH used in the EVOH layer exemplified in the laminate to be recovered, by a laminating method such as extrusion molding, blow molding, injection molding, or thermoforming, especially co-extrusion molding or co-injection molding, more especially co-extrusion molding.

The multilayer structures thus obtained are useful as packaging material containers for various products such as general foods, mayonnaise, dressings and other condiments, miso and other fermented foods, salad oil, other oils and fats, beverages, cosmetics, and pharmaceuticals, regardless of whether they are recycled or re-recycled products.

### Recovery Aid

When a method of manufacturing the resin composition of the present disclosure includes a step of recovering a multilayer structure comprising the polyolefin resin (A) layer and the EVOH (B) layer, the amine-modified resin (C) serves as an EVOH recovery aid, as described above. The EVOH recovery aid of the present disclosure contains the amine-modified resin (C). The content of the amine-modified resin (C) in the EVOH recovery aid is not particularly limited, but is preferably 1 to 100% by mass. The amine-modified resin (C) content is more preferably 10% by mass or more, further preferably 30% by mass or more, more preferably 50% by mass or more, and particularly preferably 70% by mass or more, and may be 80% by mass or more, 90% by mass or more, 95% by mass or more, or 100% by mass.

The improvement rate of external haze of the resin composition of the present disclosure is preferably 7.1% or higher, more preferably 8% or higher, further preferably 10% or higher, and particularly preferably 14% or higher compared to that which does not contain the amine-modified resin (C), which is an EVOH recovery aid. While a higher external haze improvement rate is preferable, the upper limit is typically 70%. The improvement rate of external haze can be measured, for example, using the method described in the Examples below.

### EXAMPLES

Hereinafter, the specific aspects of the present disclosure will be described in more detail using the examples. The present disclosure is not limited to the following examples without departing from the spirit and scope of the present disclosure. Values of various manufacturing conditions or evaluation results of the following examples have a meaning as preferred values of the upper or lower limits in the embodiments of the present disclosure, and the preferred range may be a range defined by a combination of the above-described upper or lower values and values in the following Examples or a combination of values in Examples.

The materials used in the following Examples, Comparative Examples, and Reference Examples are as follows.

### Regrind Composition Material

### Polyolefin Resin

Polyethylene (A1): “NOVATEC (registered trademark) UF230” manufactured by Japan Polyethylene Corporation, MFR (190° C., a load of 2.16 kg): 1 g/10 min., density: 0.921 g/cm³
Polyethylene (A2): “NOVATEC (registered trademark) UF641” manufactured by Japan Polyethylene Corporation, MFR (190° C., a load of 2.16 kg): 2.1 g/10 min., density: 0.927 g/cm³

### EVOH

EVOH (B): ethylene content of 32 mol %, saponification degree of 99.9 mol %, MFR (210° C., a load of 2.16 kg): 3.8 g/10 min., density: 1.19 g/cm³

Amine-Modified Resin (EVOH Recovery Aid)
Amine-modified hydrogenated styrenic thermoplastic elastomer (C): “Tuftec (registered trademark) MP10” manufactured by Asahi Kasei Corporation, MFR (230° C., a load of 2.16 kg): 4.0 g/10 min., density: 0.91 g/cm³

### Acid-Modified Polyolefin Resin

Acid-modified polyolefin resin (D): “MODIC (registered trademark) M512” manufactured by Mitsubishi Chemical Corporation, MFR (190° C., a load of 2.16 kg): 1.0 g/10 min., density: 0.900 g/cm³

### Example 1

### Manufacture of Multilayer Structure

By supplying (A), (B) and (D) to a multilayer co-extrusion sheet forming apparatus and performing multilayer co-extrusion molding under the following conditions, a multilayer structure (sheet) having a 3-resin 5-layer structure with the first (A) layer/(D) layer/(B) layer/(D) layer/second (A) layer was obtained. The thickness of each layer of the multilayer structure (μm) was 450/60/180/60/450.

### Multilayer Co-Extrusion Molding Conditions

(B) layer extruder: 40 mm diameter single-screw extruder (barrel temperature: 220° C.)
First (A) layer extruder: 40 mm diameter single-screw extruder (barrel temperature: 225° C.)
Second (A) layer extruder: 40 mm diameter single-screw extruder (barrel temperature: 225° C.)
(D) layer extruder: 32 mm diameter single-screw extruder (barrel temperature: 220° C.)
Die: 5-resin 7-layer feed block type T-die (die temperature: 220° C.)
Take-up speed: 1.6 m/min.
Roll temperature: 50° C.

### Preparation of Monolayer Film of Recycled Composition

The obtained multilayer sheet was crushed and melt kneaded using a twin-screw extruder (manufactured by The Japan Steel Works, Ltd., TEX30α, D=25 mm dimeter, L/D=56), at a set temperature 210° C., screw speed of 300 rpm, extrusion rate of 30 kg/h, and then strand-cut to obtain a pelletized recycled composition. The recycled composition contained 71% of (A), and 19 parts of (B) and 14 parts of (D) per 100 parts of (A).

To 100 parts of the resulting recycled composition, 5 parts of the amine-modified resin (C) (equivalent to 6.25 parts per 100 parts of (A)) were added as an EVOH recovery aid and mixed by dry-blending, and using a monolayer T die film molding machine (manufactured by GSI Creos Corporation, 40 mm dimeter, lip gap: 0.3 mm) at a set temperature 220° C. and a screw speed of 60 rpm, a film with a thickness of 0.1 mm was prepared.

### Examples 2 to 4

A film was prepared in the same manner as in Example 1, except that polyethylene (A2) was used instead of polyethylene (A1), the content of the EVOH (B) and the EVOH recovery aid (C) was changed as described in Table 2, and the thickness of each layer of the multilayer structure (μm) was changed to 521/31/95/31/521.

### Comparative Example 1

A film was prepared in the same manner as in Example 1, except that (C′1) maleic anhydride modified hydrogenated styrenic thermoplastic elastomer (“Tuftec M1943” manufactured by Asahi Kasei Corporation, MFR (230° C., a load of 2.16 kg): 8.0 g/10 min., density: 0.90 g/cm³) was used instead of the amine-modified resin (C).

### Comparative Example 2

A film was prepared in the same manner as in Example 1, except that (C′2) maleic anhydride modified hydrogenated styrenic thermoplastic elastomer (“Tuftec H1041” manufactured by Asahi Kasei Corporation, MFR (230° C., a load of 2.16 kg): 5.0 g/10 min., density: 0.91 g/cm³) was used instead of the amine-modified resin (C).

### Comparative Examples 3 to 4

A film was prepared in the same manner as in Example 2, except that the content of EVOH recovery aid (C) was changed as described in Table 2.

### Reference Example 1

A film was prepared in the same manner as in Example 1, except that the amine-modified resin (C) was not used.

### Reference Example 2

A film was prepared in the same manner as in Example 2, except that the amine-modified resin (C) was not used.

The internal haze and external haze of the films of Example 1, Comparative Examples 1 to 2, and Reference Example 1 were measured by the following method. Additionally, the improvement rate of internal haze and external haze for Example 1 and Comparative Examples 1 to 2 relative to Reference Example 1 were determined. The results are shown in Table 1.

The external haze of the films of Examples 2 to 4, Comparative Examples 3 to 4, and Reference Example 2 were measured by the following method. Additionally, the improvement rate of external haze for Examples 2 to 4 and Comparative Examples 3 to 4 relative to Reference Example 2 were determined. The results are shown in Table 2.

### Evaluation Method

### Internal Haze and External Haze

Using the films with a thickness of 0.1 mm prepared as described above, the external and internal hazes were measured using a HAZE meter with n=3, and the average values were calculated. Internal haze is an indicator used to evaluate the dispersibility of EVOH in a resin composition, and the smaller internal haze value, the more finely dispersed the EVOH is and the better the appearance. External haze is an indicator used to evaluate the surface roughness of a film, the smaller external haze value, the better the appearance of the film.

TABLE 1

| | Composition | | | | | | | |
|---|---|---|---|---|---|---|---|---|
| | | EVOH(B) | EVOH Recovery Aid | | Evaluation | | | |
| | | Content | | Content | | | Internal | External |
| | | per 100 | | per 100 | Internal | External | Haze | Haze |
| | | Parts of (A) | | Parts of (A) | Haze | Haze | Improvement | Improvement |
| | PO(A) | (Parts) | Type | (Parts) | (%) | (%) | Rate (%) | Rate (%) |
| Example 1 | A1 | 19 | C | 6.25 | 11 | 27.9 | 20 | 21.63 |
| Comparative | A1 | 19 | C′1 | 6.25 | 13.3 | 33.1 | 4 | 7.02 |
| Example 1 | | | | | | | | |
| Comparative | A1 | 19 | C′2 | 6.25 | 16.2 | 52.2 | −17 | −46.63 |
| Example 2 | | | | | | | | |
| Reference | A1 | 19 | — | 0 | 13.8 | 35.6 | — | — |
| Example 1 | | | | | | | | |

TABLE 2

| | Composition | | | | | |
|---|---|---|---|---|---|---|
| | | EVOH(B) | EVOH Recovery Aid | | Evaluation | |
| | | Content | | Content | | External |
| | | per 100 | | per 100 | External | Haze |
| | | Parts of (A) | | Parts of (A) | Haze | Improvement |
| | PO(A) | (Parts) | Type | (Parts) | (%) | Rate (%) |
| Example 2 | A2 | 12 | C | 1.18 | 6.47 | 7.17 |
| Example 3 | A2 | 12 | C | 5.88 | 5.91 | 15.21 |
| Example 4 | A2 | 12 | C | 17.65 | 5.74 | 17.65 |
| Comparative | A2 | 12 | C | 0.06 | 7.14 | −2.44 |
| Example 3 | | | | | | |
| Comparative | A2 | 12 | C | 23.53 | 6.53 | 6.31 |
| Example 4 | | | | | | |
| Reference | A2 | 12 | — | 0 | 6.97 | — |
| Example 2 | | | | | | |

From Example 1, it can be seen that using an amine-modified resin as an EVOH recovery aid results in superior internal and external hazes and transparency of the molded product, compared to using no recovery aid or using an unmodified resin or another modified resin as a recovery aid.

Furthermore, from Examples 2 to 4 and Comparative Examples 3 to 4, it can be seen that using amine-modified resin in the amount specified in the present disclosure results in superior transparency of the molded product compared to using amine-modified resin in an amount outside the specified range in the present disclosure.

When recycling an olefin resin composition containing EVOH, the generally low compatibility between EVOH and the olefin resin composition results in poor dispersibility of EVOH in the olefin resin and a molded product with poor transparency. In Example 1, it is thought that the dispersibility of EVOH in the olefin resin was improved by the amine-modified resin forming excellent hydrogen bonds with the vinyl alcohol groups in the EVOH, resulting in improved transparency of the molded product.

While specific forms of the embodiment of the present disclosure have been shown in the above Examples, the Examples are merely illustrative, and should not be construed as limiting. It is contemplated that various modifications apparent to those skilled in the art could be made within the scope of the present disclosure.

1. A resin composition, comprising:
a polyolefin resin (A),
an ethylene-vinyl alcohol copolymer (B), and
an amine-modified resin (C),
wherein the content of the amine-modified resin (C) is 0.1 to 20 parts by mass per 100 parts by mass of the polyolefin resin (A).

2. The resin composition according to claim 1, wherein the content of the ethylene-vinyl alcohol copolymer (B) is 0.1 to 20 parts by mass per 100 parts by mass of the polyolefin resin (A).

3. The resin composition according to claim 1, wherein the content of the ethylene-vinyl alcohol copolymer (B) and the content of the amine-modified resin (C) are 0.1 to 20 parts by mass and 0.1 to 20 parts by mass, respectively, per 100 parts by mass of the polyolefin resin (A).

4. The resin composition according to claim 1, wherein the amine-modified resin (C) is an amine-modified block copolymer of an aromatic vinyl compound and an olefin.

5. The resin composition according to claim 1, further comprising 0.1 to 20 parts by mass of an acid-modified polyolefin resin (D) per 100 parts by mass of the polyolefin resin (A).

6. A molded product comprising:
the resin composition according to claim 1.

7. A multilayer structure comprising:
at least one layer comprising the resin composition according to claim 1.

8. A method of enhancing recyclability of a combination of an ethylene-vinyl alcohol copolymer and a polyolefin resin, comprising: adding an amine-modified resin (C) to the combination of the ethylene-vinyl alcohol copolymer and the polyolefin resin.
